(19) United States
(12) Patent Application Publication
(10) Pub. No.: US 2024/0240595 A1
(43) Pub. Date: Jul. 18, 2024

(54) DRIVE SYSTEM AND DETERMINING METHOD FOR DETERMINING A TEMPERATURE IN A METERING SYSTEM OF A DRIVE SYSTEM

(71) Applicant: Robert Bosch GmbH, Stuttgart (DE)

(72) Inventors: Timo Bosch, Renningen (DE); Tobias Falkenau, Esslingen (DE)

(21) Appl. No.: 18/575,923

(22) PCT Filed: Jun. 27, 2022
(86) PCT No.: PCT/EP2022/067489

§ 371 Date: Jan. 2, 2024

(30) Foreign Application Priority Data
Jul. 12, 2021 (DE) 10 2021 207 351.4

(51) Int. Cl. F02D 19/02; H01M 8/0432; H01M 8/0438; H01M 8/0444; H01M 8/04858

(52) U.S. Cl. CPC F02D 19/028; H01M 8/0432; H01M 8/0438; H01M 8/0444; H01M 8/04932; H01M 2250/20

(57) ABSTRACT

The invention presented relates to a drive system (100) for providing energy for driving a load. The drive system (100) comprises a compressed gas tank (101) with a pressure sensor (103) and a temperature sensor (105), an energy converter (107) for converting energy from a gas stored in the compressed gas tank (101) into drive energy, a metering system (109) for metering gas from the compressed gas tank (101) into the energy converter (107), and a control device (111) configured to calculate a temperature of gas flowing in the metering system (109) by means of a mathematical model (200) that models an isenthalpic state change of gas flowing into the metering system (109) from the compressed gas tank (101). The control device (111) is furthermore configured to provide measured values that were determined by means of the pressure sensor (103) and/or the temperature sensor (105) as input values to the mathematical model (200). The control device (111) is furthermore configured to provide the calculated temperature of the gas flowing into the metering system (109) to a supplementary system.

### BACKGROUND

In vehicles with a hydrogen drive in particular, fuel is stored in compressed gas tanks and/or in a cryogenic state.

In compressed gas tanks, fuel is in gaseous form at pressures of up to 875 bar and temperatures between −40 and 85° C. In liquid form at pressures up to 50 bar and temperatures down to −265° C.

In order to protect system components of a drive system with an energy converter downstream of a respective compressed gas tank, an inlet temperature of fuel into a metering system for metering gas from a respective compressed gas tank into the energy converter must be in a temperature range between a minimum of −40° C. and 120° C., ideally between −20° C. and 95° C., as specified, for example, in the UN/ECE R79 regulation.

Furthermore, it is regulated by law that hydrogen compressed gas tanks in motor vehicles must have a sensor for tank pressure and temperature per tank and provide corresponding information via a communication interface, as specified, for example, in the SAE J2579 and UN/ECE R79 regulations.

Fuel cell systems or fuel supply systems operate at a pressure that is lower than the pressure in a compressed gas tank. For example, fuel cell systems operate at a pressure of between 3 and 30 bar_g, wherein bar_g is a pressure referenced against an ambient pressure.

A state change of a gas during expansion of the gas from a compressed gas container to a metering system causes the temperature of the gas to change.

### SUMMARY

In the context of the invention presented, a drive system, a tank system, a vehicle, and a determining method for determining a temperature in a metering system of a drive system are presented. Further features and details of the invention will emerge from the respective dependent claims, the description, and the drawings. Features and details which are described in connection with the drive system according to the invention or the tank system according to the invention and/or the vehicle according to the invention naturally also apply in connection with the determining method according to the invention and vice versa in each case, so that reference is or can always be made reciprocally with regard to the disclosure of the individual aspects of the invention.

The invention presented here serves to provide a way of determining a temperature in a metering system of a drive system. In particular, the invention presented serves to determine a temperature of a gas introduced from a compressed gas tank or several compressed gas tanks into a metering system of a drive system without using a sensor or several sensors in the metering system.

In a first aspect of the invention presented, a drive system for providing energy to drive a load is thus presented. The drive system comprises a compressed gas tank having a pressure sensor and a temperature sensor, an energy converter for converting energy from a gas stored in the compressed gas tank into drive energy, a metering system for metering gas from the compressed gas tank into the energy converter, and a control device configured to calculate, by means of a mathematical model that models an isenthalpic state change of gas flowing from the compressed gas tank into the metering system, a temperature of gas flowing in the metering system, a temperature of gas flowing in the metering system, wherein the control device is further configured to provide the mathematical model with measured values determined by means of the pressure sensor and the temperature sensor as input values, and wherein the control device is further configured to provide the calculated temperature of the gas flowing in the metering system to a supplementary system.

In the context of the invention presented, an energy converter is to be understood as a system for converting potential energy stored in a fuel, such as hydrogen, into drive energy for propelling a vehicle. An energy converter can be, for example, a fuel cell system or an internal combustion engine, in particular a reciprocating piston engine or a rotary piston engine.

In the context of the invention presented, a metering system is to be understood as a system for metering or feeding fuel into an energy converter. A metering system can be an injection system or an anode subsystem, for example. In particular, a metering system comprises a metering section in which gaseous fuel flowing out of a compressed gas tank expands before the fuel is fed to the respective energy converter.

In the context of the invention presented, a control device is to be understood as a programmable circuit, such as a processor or an ASIC. For example, a control device can be a control unit of an energy converter.

The drive system presented is based on measured values provided by a temperature sensor and a pressure sensor of a compressed gas tank of the drive system. These measured values are used to determine the temperature of the gas or fuel flowing into the metering system of the drive system. For this purpose, the measured values are fed into a mathematical model that is executed by the control device of the drive system presented.

The mathematical model provided according to the invention models an isenthalpic state change of gas flowing from the compressed gas tank into the metering system. For this purpose, different characteristic curves of isenthalpic state changes for different pressures or different temperatures in the compressed gas tank can be stored in the control device provided according to the invention, so that, depending on how much time has passed or how much distance has been covered since a quantity of gas has escaped from the compressed gas tank and flowed into the metering system, a corresponding temperature of the gas flowing in the metering system can be determined.

As an alternative or in addition to the respective characteristic curves, the mathematical model can comprise a mathematical formula that mathematically represents a change in the temperature of a gas based on measured pressure and temperature values determined in the compressed gas tank. Accordingly, a temperature of the gas flowing in the metering system can be determined using the mathematical formula. The mathematical formula can, for example, mathematically map heat losses via pipes and surfaces of the metering system.

By using the control device provided according to the invention to determine a temperature of a gas flowing in the metering system of the drive system presented, error-prone sensors in the metering system can be dispensed with. Accordingly, the drive system presented is particularly robust and reliable.

As soon as the temperature of a gas currently flowing in the metering system of the drive system presented is known or has been determined by the control device, the temperature can be provided to a supplementary system, such as a central control unit of the drive system and/or a display unit.

To provide a respective determined temperature, the control device of the drive system presented can store a value of the determined temperature in a memory for retrieval or transmit the value of the determined temperature to a supplementary system via a communication interface.

It may be provided that the energy converter is a fuel cell system.

In the event that the energy converter is a fuel cell system, a respective temperature determined by the control device can be used in the metering system, which is then, for example, an anode subsystem, in order to adjust the fuel cell system to the temperature of the gas or to adjust a gas supply so that gas flowing in the metering system assumes a predetermined temperature. For example, a valve on the compressed gas tank can be opened or closed accordingly. Alternatively, a valve for introducing gas from the anode subsystem into a fuel cell stack of the fuel cell system can be activated or deactivated in such a way that a predetermined temperature is set in the anode subsystem and/or the fuel cell stack.

Alternatively or additionally, a coolant temperature or a coolant flow of coolant flowing in the anode subsystem can be adjusted in order to set a desired gas temperature in the metering system or the anode subsystem.

When using several compressed gas tanks, it can be provided that individual tanks with temperatures or pressures that are too high or too low, i.e., temperatures or pressures that are above or below a predetermined threshold value, are disconnected or switched off from the metering system in order to ensure continued operation of the drive system presented.

It is also possible that the energy converter is an internal combustion engine.

In the event that the energy converter is an internal combustion engine, such as, for example, a reciprocating piston engine or a rotary piston engine, which is configured in particular for the combustion of hydrogen, a respective temperature determined by the control device can be used in the metering system, which then, for example, an injection system with a supply tract, such as a so-called “rail”, can be used to adjust the combustion engine to the temperature of the gas or to adjust a gas supply so that the gas flowing in the injection system assumes a predetermined temperature. For example, a valve on the compressed gas tank can be opened or closed accordingly. Alternatively, a valve for introducing gas from the injection system into the internal combustion engine can be activated or deactivated in such a way that a predetermined temperature is set in the injection system and/or the internal combustion engine.

It is also possible that the load is a mechanical system.

The drive system presented is particularly suitable for driving a mechanical system, such as a machine, in particular a gearbox and/or a mechanism for moving the wheels of a vehicle.

It may further be provided that the mathematical model comprises a correction term that mathematically represents an influence of a pressure reducer and/or a supply channel for supplying gas from the compressed gas tank to the energy converter.

In order to minimize a variance due to an influence of a component, such as a pressure reducer and/or a supply channel, such as a shape and/or a material of the pressure reducer and/or the supply channel on the temperature of gas flowing in the metering system of the drive system presented, a mathematical correction term is suitable, which is determined specifically for a respective pressure reducer and/or supply channel, for example in laboratory tests by means of experimental measurements.

It can also be provided that an area between the compressed gas tank and the energy converter is pressure sensor-free and temperature sensor-free.

A pressure sensor-free or temperature sensor-free area between the compressed gas tank and the energy converter of the drive system presented here means that error-prone sensors can be dispensed with and a particularly long service life of the drive system can be achieved.

It may further be provided that the drive system comprises a plurality of pressure accumulators, each comprising a pressure sensor and a temperature sensor, and the control device is configured to provide the mathematical model with averaged measured values of the respective temperature sensors and pressure sensors of the respective pressure accumulators as input values.

In order to map the influence of several compressed gas tanks on the drive system presented and to report it to the respective supplementary systems, an averaging process in which the measured values determined at the respective compressed gas tanks are averaged has proven to be suitable. Alternatively, it is possible that only the measured values determined by a tank currently used to supply fuel to the metering system or a predetermined master tank or a master tank automatically selected according to a predetermined criteria catalog are used by the control device.

In a second aspect, the presented invention relates to a determining method for determining a temperature in a metering system of a drive system. The drive system comprises a compressed gas tank with a pressure sensor and a temperature sensor, an energy converter for converting energy from a gas stored in the compressed gas tank into drive energy, and a metering system for metering gas from the compressed gas tank into the energy converter. The determining method comprises a determining step in which a pressure and a temperature in the compressed gas tank are determined, a modeling step in which an isenthalpic state change of gas flowing from the compressed gas tank into the metering system is modeled by means of a mathematical model, and a calculating step in which a temperature of the gas flowing into the metering system is calculated by means of the mathematical model,
a providing step for providing the calculated temperature of the gas flowing into the metering system to a supplementary system.

In a third aspect, the invention presented relates to a vehicle with a possible embodiment of the drive system presented.

In a fourth aspect, the presented invention relates to a tank system for providing a gas into a metering system of an energy converter, wherein the tank system comprises a compressed gas tank with a pressure sensor and a temperature sensor and a control device. The control device is configured to calculate a temperature of gas flowing in the metering system of the energy converter by means of a mathematical model that models an isenthalpic state change of gas flowing from the compressed gas tank into the metering system of the energy converter. The control device is also configured to provide the mathematical model with measured values determined by the pressure sensor and the temperature sensor as input values. The control device is also configured to provide the calculated temperature of the gas flowing into the metering system to a supplementary system.

Further advantages, features, and details of the invention will emerge from the following description, in which exemplary embodiments of the invention are described in detail with reference to the drawings. In this context, the features specified in the claims and in the description can each be essential to the invention, individually or in any combination.

### BRIEF DESCRIPTION OF THE DRAWINGS

In the drawings:

FIG. 1 a schematic representation of a possible configuration of the drive system presented,

FIG. 2 a schematic representation of a mathematical model used by a control device of the drive system according to FIG. 1,

FIG. 3 a schematic arrangement of the determining method presented,

FIG. 4 a schematic representation of a possible configuration of the vehicle presented,

FIG. 5 a schematic representation of a possible design of the tank system presented.

### DETAILED DESCRIPTION

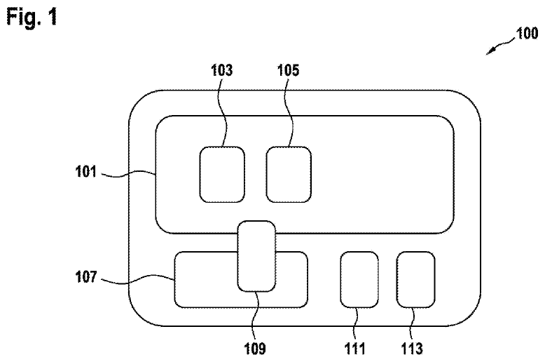

FIG. 1 shows a drive system 100. The drive system 100 comprises a compressed gas tank 101 with a pressure sensor 103 and a temperature sensor 105.

Furthermore, the drive system 100 comprises an energy converter 107 for converting energy from a gas stored in the compressed gas tank into drive energy.

Furthermore, the drive system 100 comprises a metering system 109 for metering gas from the compressed gas tank 101 into the energy converter 107.

Furthermore, the drive system 100 comprises a control device 111. The control device 111 is configured to calculate a temperature of gas flowing in the metering system 109 by means of a mathematical model that models an isenthalpic state change of gas flowing from the compressed gas tank 101 into the metering system 109.

The control device 111 is further configured to provide measured values, which were determined by means of the pressure sensor 103 and the temperature sensor 105, as input values to the mathematical model.

The control device 111 is further configured to provide the calculated temperature of the gas flowing into the metering system 109 to a supplementary system 113, such as a display or a central control unit for controlling the energy converter 107.

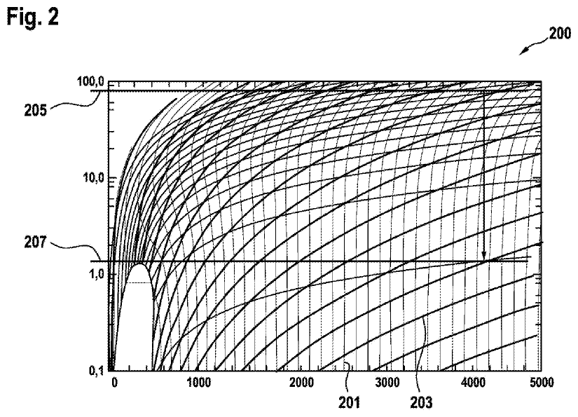

A mathematical model 200 is visualized in FIG. 2. The model 200 comprises a plurality of characteristic curves in the form of isotherms 201 and isentropes 203, which can be used to infer from a first state, represented by a first area 205, such as in a compressed gas tank, to a second state, represented by a second area 207, such as in a metering system. Since the pressure in a metering system is usually known, the known pressure can be used to infer a temperature for the second state, i.e., in the pressurized system, if the initial temperature for the first state, i.e., in the compressed gas tank, is known.

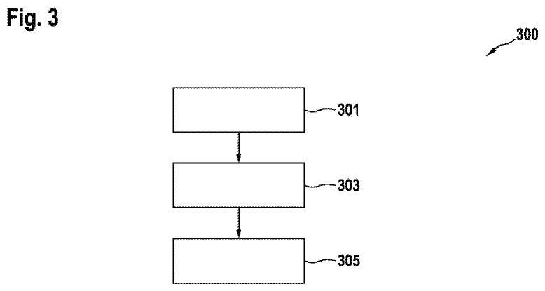

FIG. 3 shows a determining method 300 for determining a temperature in a metering system of a drive system, such as the drive system 100 according to FIG. 1.

The determining method 300 comprises a determining step 301, in which a pressure and a temperature in the compressed gas tank are determined, a modeling step 303, in which an isenthalpic state change of gas flowing from the compressed gas tank into the metering system is modeled using a mathematical model, and a calculation step 305, in which a temperature of the gas flowing into the metering system is calculated using the mathematical model, and a provision step 307 for providing the calculated temperature of the gas flowing into the metering system for a supplementary system.

In the modeling step 303, measured values determined in the determining step 301 are entered into the mathematical model and model parameters are specified, such as a respective characteristic curve and/or a respective correction term is selected, for example.

In the calculation step 305, the model parameters selected in the modeling step are applied to the calculation and a temperature is calculated.

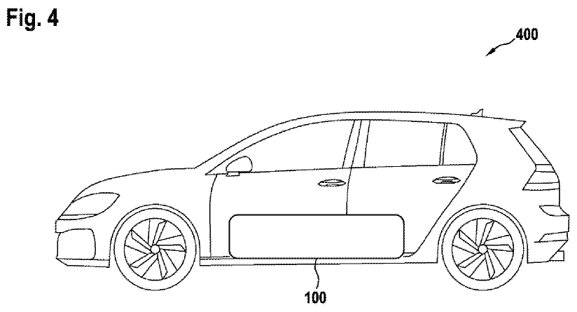

FIG. 4 shows a vehicle 400. The vehicle 400 comprises a drive system 100 as shown in FIG. 1.

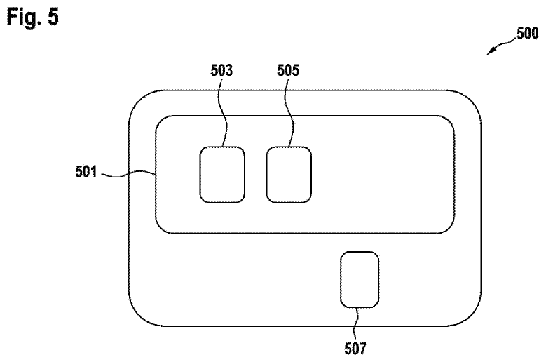

FIG. 5 shows a tank system 500. The tank system 500 comprises a compressed gas tank 501 with a pressure sensor 503 and a temperature sensor 505 as well as a control device 507.

The control device 507 is configured to model, using a mathematical model that models an isenthalpic state change of gas flowing from the compressed gas tank into a metering system of a metering system of an energy converter supplied with fuel from the tank system 500, and to calculate a temperature of gas flowing in the metering system.

Furthermore, the control device 507 is configured to provide the mathematical model with measured values determined by means of the pressure sensor 501 and the temperature sensor 503 as input values and to provide the calculated temperature of the gas flowing into the metering system to a supplementary system.

1. A drive system (100) for providing energy to drive a load, the drive system (100) comprising:
a compressed gas tank (101) with a pressure sensor (103) and a temperature sensor (105),
an energy converter (107) for converting energy from a gas stored in the compressed gas tank (101) into drive energy,
a metering system (109) for metering gas from the compressed gas tank (101) into the energy converter (107), and
a control device (111) configured to calculate a temperature of gas flowing in the metering system (109) by means of a mathematical model (200) that models an isenthalpic state change of gas flowing from the compressed gas tank (101) into the metering system (109),
wherein the control device (111) is further configured to provide the mathematical model (200) with measured values, which were determined by means of the pressure sensor (103) and/or the temperature sensor (105), as input values,
wherein the control device (111) is further configured to provide the calculated temperature of the gas flowing into the metering system (109) to a supplementary system.

2. The drive system (100) according to claim 1,
wherein
the energy converter (107) is a fuel cell system.

3. The drive system (100) according to claim 1,
wherein
the energy converter (107) is an internal combustion engine.

4. The drive system (100) according to claim 1,
wherein
the load is a mechanical system.

5. The drive system (100) according to claim 1,
wherein
the mathematical model (200) comprises a correction term which mathematically represents an influence of a pressure reducer and/or a supply channel for supplying gas from the compressed gas tank (101) to the energy converter (107).

6. The drive system (100) according to claim 1,
wherein
an area between the compressed gas tank (101) and the energy converter (107) is pressure sensor-free and temperature sensor-free.

7. The drive system (100) according to claim 1,
wherein
the drive system (100) comprises a plurality of pressure accumulators (101), each comprising a pressure sensor (103) and a temperature sensor (105), and the control device (111) is configured to provide the mathematical model (200) with averaged measured values of the respective pressure sensors (103) and temperature sensors (105) of the respective pressure accumulators (101) as input values.

8. The drive system (100) according to claim 1,
wherein
the mathematical model (200) comprises a characteristic curve of an isenthalpic state change of a respective gas.

9. A method (300) for determining a temperature in a metering system (109) of a drive system (100), wherein the drive system (100) comprises:
compressed gas tank (101) with a pressure sensor (103) and a temperature sensor (105),
an energy converter (107) for converting energy from a gas stored in the compressed gas tank (101) into drive energy, and
a metering system (109) for metering gas from the compressed gas tank (101) into the energy converter (107),
wherein the determining method (300) comprises:
a determining step (301) in which a pressure and a temperature in the compressed gas tank (101) are determined,
a modeling step (303) in which an isenthalpic state change of gas flowing from the compressed gas tank (101) into the metering system (109) is modeled by means of a mathematical model (200),
a calculation step (305) in which a temperature of the gas flowing into the metering system (109) is calculated by means of the mathematical model (200), and
a providing step (307) for providing the calculated temperature of the gas flowing into the metering system (109) to a supplementary system.

10. A vehicle (400) comprising a drive system (100) according to claim 1.

11. A tank system (500) for supplying a gas to a metering system (109) of an energy converter (107),
wherein the tank system (500) comprises:
a compressed gas tank (501) with a pressure sensor (503) and a temperature sensor (505), and
a control device (507),
wherein the control device (507) is configured to calculate a temperature of gas flowing in the metering system (109) of the energy converter (107) by means of a mathematical model (200) that models an isenthalpic state change of gas flowing from the compressed gas tank into the metering system (109) of the energy converter (107),
wherein the control device (507) is further configured to provide measured values determined by means of the pressure sensor (503) and the temperature sensor (505) as input values to the mathematical model (200), wherein the control device (507) is further configured to provide the calculated temperature of the gas flowing into the metering system (109) to a supplementary system.
